(19) United States
(12) Patent Application Publication
(10) Pub. No.: US 2020/0230897 A1
(43) Pub. Date: Jul. 23, 2020

(54) METHOD FOR PRODUCING A COMPOSITE MATERIAL PART, STEERING COLUMN SUPPORT AND LOWER SPACE CROSS MEMBER PRODUCED BY SUCH A METHOD

(71) Applicant: INSTITUT DE RECHERCHE TECHNOLOGIQUE JULES VERNE, Bouguenais (FR)

(72) Inventors: Matthieu KNEVELER, Les Sorinieres (FR); Charles LEROUX, Bullion (FR); Laurent ROTA, Saint Cheron (FR)

(73) Assignee: INSTITUT DE RECHERCHE TECHNOLOGIQUE JULES VERNE, Bouguenais (FR)

(21) Appl. No.: 16/840,965

(22) Filed: Apr. 6, 2020

Related U.S. Application Data
(62) Division of application No. 16/312,116, filed on Dec. 20, 2018.

(30) Foreign Application Priority Data
Jun. 20, 2016 (FR) 1655722

(51) Int. Cl. B29C 70/48; B62D 29/04; B62D 25/14; B29C 70/08; B29B 11/16; B29C 70/54; B29C 70/38

(52) U.S. Cl. CPC B29C 70/48; B62D 29/04; B62D 25/14; B29C 70/38; B29B 11/16; B29C 70/543; B29C 70/086

(57) ABSTRACT

A method for producing a part made of a composite material having an organic matrix and a fibrous reinforcement, the method comprising the following steps: a) automatically draping, either in a planar arrangement or shaped over a three-dimensional cavity, at least one lamination (30, 31) comprising at least a first and second different dry plies, at least partially stacked to form a dry, planar or three-dimensional preform, each ply being fibrous and the plies mutually differing in terms of their structure, their positioning on the preform, the fibres composing them and/or the geometry of the ply, wherein at least one ply is laid in a non-woven form and has a plurality of unidirectional fibre layers laid on top of each other with a different angular orientation of the fibres, and/or at least one ply is woven; b) thermoforming the preform, the thermoforming step taking place, when the preform has been draped in a planar arrangement in step a), in a three-dimensional cavity of a first mold to impart a three-dimensional shape thereto; and c) impregnating, with at least one polymer, the preform thus thermoformed inside a mold, the preform being moved, if it is draped in a planar arrangement in step a), from the first thermoforming mold to a second mold for the impregnation step.

### CROSS-REFERENCE TO RELATED APPLICATIONS

This document is a divisional application of and is based upon and claims the benefit of priority under 35 U.S.C. § 120 from U.S. Ser. No. 16/312,116, filed Dec. 20, 2018, herein incorporated by reference, which is a National Stage Application of International Application No. PCT/EP2017/065061, filed Jun. 20, 2017, which claims priority to French application No. 1655722 filed Jun. 20, 2016.

### FIELD OF THE INVENTION

The present invention relates to a method for producing a part made of a composite material having an organic matrix and fiber reinforcement, in particular but not exclusively in the automobile or aeronautical field.

The invention also relates to a steering column support and a windshield recess lower crossmember made notably using such a method of production.

### BACKGROUND

In the automobile industry, numerous parts are made of metal, and there are currently efforts to replace metal with composite material having an organic matrix, notably for weight reduction and therefore reduction of the vehicle's fuel consumption or improvement of battery service life in the case of a hybrid or electric vehicle. To do this, it is necessary for the mechanical performance obtained to be comparable, for the production rates to be high enough to be able to be employed in an automobile production line and for the total cost to be comparatively acceptable or even favorable.

Replacement of a metal tubular crossmember with a crossmember made of fiber composite is known from WO 2013/182521. Such a crossmember requires a large amount of composite material to obtain the same mechanical properties as the metal crossmember, which increases the production costs, weight and volume of the assembly.

WO 2015/090989 relates to a dashboard crossmember for a motor vehicle together with two lateral supports, the crossmember comprising a tube, at least one part of which is made of plastic composite material and one of the lateral supports is made of plastic composite material, said plastic composite material being reinforced with one or more metal plates bonded to the plastic by overmolding or gluing.

FR 3 014 401 describes a front bulkhead for a motor vehicle body intended to separate the engine compartment and the passenger compartment of the vehicle, consisting of assembling together a plurality of individual monolithic parts each formed in a composite material based on a mixture of a reinforcement and a matrix.

EP 2 716 527 discloses a device for fixing the steering column of a motor vehicle to the dashboard crossmember and to a part of the structure of the vehicle body.

A dashboard crossmember for a motor vehicle consisting of two tubes joined together axially and a strut extending in a transverse direction relative to the crossmember, the tubes and the strut being made of composite material, is also known from FR 2 995 862.

Other patent documents describe composite materials used at least partially for making automobile parts such as dashboard, dashboard crossmember, dashboard, front bulkhead, including EP 2 597 017, FR 2 975 961, EP 2 377 747, EP 2 332 809, EP 2 179 910, WO 2010/017254, EP 2 113 448, WO 2005/037632, WO 01/70558. Certain publications specifically describe supporting structures for a steering column, notably JP 2015182736 or EP 2 896 545.

U.S. Pat. No. 8,623,159 describes a method comprising flat production of a preform comprising foam cores.

Moreover, in the field of methods for making parts starting from preforms, US 2014/0300138 teaches making a part of an automobile floor by assembling several dry preforms in a mold before impregnating them by resin infusion. This method of the prior art is difficult to automate and does not allow a high production rate, compatible with long production runs, to be achieved economically.

A method is also known from WO 2015/170016 for making preforms by application, without compacting, of continuous fibers, preferably unidirectional, in defined orientations. Such a method, which uses draping layer by layer, is suitable, notably owing to its manageability and its precision, for applications in small production runs, bespoke and top-of-the-range. However, this method is not suitable for mass production, owing to its low production rate and high development cost. In fact, the principle of these methods is draping, typically on molds or parts (not flat), layer by layer and by means of special draping heads carried by a robot, plies of a single thickness, each ply consisting of continuous flat fibers (rovings) arranged side by side. The width of each ply, which corresponds to that of the head, is typically from 3 to 10 cm. These heads, familiar to a person skilled in the art, have a deposition capacity of the order of 1 to 5 kg/h.

Thus, the methods and devices according to WO 2015/170016 are not at all suitable for parts of large dimensions, typically of several meters, with a thickness of the preform typically corresponding to at least 3 to 5 layers and a high desired deposition rate of the order of 30 to 100 kg/h. In fact to achieve such a deposition rate it would be necessary to use a very expensive and complex system equipped with several robots and heads.

Moreover, in a given plane, the edge-to-edge juxtaposition of fairly narrow bands of fibers as proposed in WO 2015/170016 gives lower mechanical strength than a wide band of continuous fibers.

Moreover, these heads do not allow the use of reinforcements (cores) of sufficiently flexible material (deformable, thermoformable) in the forming mold, which are inexpensive and capable, during the forming step, of adjusting their shape between the plies of the preform. In contrast, as described later on in the text, the applicant's method allows flat preparation of the dry preforms incorporating such cores (not preformed and rigid) between the plies, then placement of these preforms in the forming mold. Finally, methods are known for making parts based on composite material, of the stamping type, leading to losses of material and requiring very expensive completion steps. This type of method, reserved for top-of-the-range parts in small production runs, is incompatible with the constraints of production costs for mass-produced parts.

Despite all this known prior art, there is still a need to be able to produce a complex part made of composite material having an organic matrix, at a relatively high production rate if this is desired and at a cost that is lower or comparable to that of an equivalent metal part.

There are also benefits in broadening the aesthetic possibilities in the design of the dashboards and in reducing the number of parts to be assembled in a motor vehicle, the time for setup and assembly of a motor vehicle and/or the volume of stored preforms.

### SUMMARY

Method of Production

The invention thus relates, according to a first aspect, to a method for producing a part made of a composite material having an organic matrix and fiber reinforcement, comprising the following steps:

a) draping, preferably automatically, respectively flat or shaped on a three-dimensional mold cavity, at least one layered structure comprising at least one first ply and one second ply, preferably dry, different, at least partially superposed, so as to form a preform, preferably dry, either flat or three-dimensional, each ply being fibrous, the plies differing from one another in structure, positioning on the preform, the fibers of which they are constituted and/or the geometry of the ply,

b) thermoforming the preform, thermoforming being carried out, when it was draped flat in step a), in a three-dimensional cavity of a mold in order to give it a three-dimensional shape,

c) impregnating, within a mold, the preform thus thermoformed with at least one polymer, the preform being moved, in the case of flat draping in step a), from the first thermoforming mold to a second mold for impregnation.

Owing to the invention, we have at our disposal a quick method of production, starting from a single preform, with a method of draping that can be automated, for making complex composite parts, including parts of large dimensions, for example from 5 to 8 m², or with complexity of shape and/or structure, intended for the automotive sector, aeronautical sector, or any other industrial sector.

By combining said at least two different plies in the preform it is possible to produce a complex preform in one piece, the mechanical characteristics of which are suitable for the subsequent stresses on the part.

The layered structure thus comprises a plurality of plies, at least two in number, at least some of which advantageously have different shapes, notably different dimensions, for positioning at different locations in the preform. This can make it possible to reinforce certain zones of the part, and/or adapt to a complex shape of the latter. Thus, the final part could have zones that are reinforced relative to other zones. This may also allow adaptation or local variation of the properties of elasticity or other mechanical properties such as stiffness and deformability, of different zones of the part as a function of the subsequent mechanical stresses on the part produced in this way. Thus, it is possible to obtain a part with zones that are relatively elastic or deformable and other zones that are rigid and cannot be deformed. It is also possible to make use of the different nature of the fibers, by mixing glass fibers and carbon fibers in certain places as a function of the mechanical stresses.

“Dry preform” denotes a fibrous preform comprising between about 1% and 20%, notably less than about 5%, of a thermosetting or thermoplastic polymer, in percentage by weight relative to the total weight of the preform. The dry preform is used as the reinforcing phase of a composite material, the part corresponding to said preform being obtained by impregnation, notably injection or infusion, of a polymer in the liquid or pasty state in said dry preform.

The term “dry ply” denotes a ply of fibers impregnated with a small amount of a thermosetting or thermoplastic polymer, in an amount between about 1% and 20%, notably less than about 5% by weight relative to the total weight of the ply. The polymer, which is present in a small amount, may be dusted in the form of powder on the ply or may form a film between two layers of the ply, etc.

Throughout the text, the term “cavity”, unless mentioned particularly, denotes both a hollow mold and a mold in relief.

Each ply may have a structure selected from the group consisting of a linear structure, notably yams or rovings, a surface structure, notably nonwovens, fabrics, tapes or mats, or multidirectional, notably braidings, complex fabrics, multi-directional weaving, notably in three or more directions.

At least one ply may be arranged, i.e. deposited by draping, in a nonwoven form, also called Noncrimp Fabrics (NCF). In this case, the ply comprises a plurality of layers of unidirectional fibers, arranged on top of one another with a different angular orientation of the fibers, for example in a sequence 0/+−45°/90°. Thus, by draping a single ply, this ply contains several layers simultaneously, which gives a better production rate than when a single layer, for example of unidirectional fibers, is deposited at a time. When the first and second plies are made of nonwoven, they may for example differ in angular orientation of the layers that they contain. The layers forming the nonwoven ply may be stitched together.

As a variant or additionally, at least one ply may be woven. In this case, the ply is advantageously monolayer.

The term “woven” covers various structures from weaving and braiding, of varying complexity, which may in particular be three-dimensional. In a manner known per se, the weaving may be a cloth, a serge, a satin, a unidirectional fabric, a mock gauze or some other.

It is possible to have a combination of nonwoven ply or plies and of woven ply or plies.

It is also possible to have a combination of multilayer nonwoven ply or plies, which is/are suitable for zones or parts with less complex geometry and of monolayer woven or nonwoven ply or plies, which may be suitable for zones or parts with more complex geometry.

The plies are preferably deformable. The term “deformable ply” denotes a ply made up of continuous fibers arranged in defined directions and assembled in the form of woven or nonwoven fabric. The fibers making up the plies may be selected from the group consisting of carbon fibers, glass fibers, aramid fibers, ceramic fibers, polyester fibers, fibers of vegetable origin, notably flax fibers, preferably carbon fibers or glass fibers, and a mixture thereof. The fibers may be continuous or short.

One advantage of the invention is that it may make it possible to use NCF nonwoven fibers, which form a raw material of lower cost relative to woven fibers. Moreover, it is possible to select the orientation of the fibers for draping, allowing the mechanical properties of the part to be controlled, or even giving better performance. Generally, the draping step may be carried out by selecting the orientations of the fibers of the plies so as to obtain the target properties of the different parts of the component.

The method advantageously comprises a preliminary step of design of the part, so as to predetermine the choice of the shape, of the fiber or fibers, of the positioning and of the geometry of each ply, as a function of the mechanical characteristics required for the part.

The method may comprise a step consisting of placing at least one core on at least one part of the layered structure.

The method may comprise the step of draping a second layered structure comprising at least one ply, in order to cover the core and the layered structure at least partially.

In this case, we have a sandwich structure, for at least a portion of the part in which the core is present.

“Sandwich structure” means a structure formed of a core of a first material, sandwiched between two outer layers of one or more other materials. The core may be lightweight and may, in itself, have low mechanical characteristics, whereas the outer layers may have high mechanical characteristics. The thickness of the core may be greater than about ten times the thickness of the outer layers.

According to a first embodiment, the method according to the invention, for producing a part made of a composite material having an organic matrix, comprises the following steps:

automatic flat draping of at least one layered structure comprising at least one first and one second different dry plies at least partially superposed, each ply being fibrous, so as to form a flat dry preform, the plies differing from one another with respect to structure, positioning on the preform, the fibers of which they are constituted and/or the geometry of the ply,

if necessary, assembling said at least two plies, notably with at least one seam,

positioning the preform flat in a first mold,

thermoforming the preform to give it a three-dimensional shape,

moving the preform thus thermoformed into a second mold,

impregnating the thermoformed preform with at least one polymer in the second mold in order to produce the part.

According to a second embodiment, the method according to the invention, for producing a part made of a composite material having an organic matrix, comprises the following steps:

draping on a three-dimensional mold cavity, not flat, at least one layered structure comprising at least one first and one second different plies, at least partially superposed, each ply being fibrous, so as to form a dry three-dimensional preform, the plies differing from one another in structure, positioning on the preform, the fiber or fibers making them up and/or the geometry of the ply,

thermoforming the three-dimensional preform,

impregnating the preform with at least one polymer in a mold in order to produce the part.

Regardless of the manner of carrying it out, the method may be as defined hereunder.

The thermoforming, or preforming, whether the preform is flat or three-dimensional, may be carried out on a simple mold, with heating for example by radiant panel to a temperature less than or equal to about 100° C., forming preferably taking place at low pressure, for example of about 1 bar, which allows a fibrous structure to be obtained that may be introduced into a mold for impregnation, for example injection. The mold may be made of metal such as aluminum or of composite material with an organic matrix or of resin.

Thermoforming makes it possible to compress the layered structure to bring it to a final thickness. This operation makes it possible to close the mold for impregnation with the polymer or polymers.

In the case of thermoforming of the three-dimensional preform, this step may take place in the three-dimensional mold cavity used for draping, in the mold used for impregnation or in another mold.

The three-dimensional mold cavity may form part of the mold for impregnation with the polymer or polymers. As a variant, the preform may be moved from the three-dimensional mold cavity or from another mold to a second mold for the impregnation step.

It should be noted that it is preferable for the mold for thermoforming to be different than the mold for impregnation. In fact, these types of molds are different, and do not operate with the same ranges of temperature and pressure. The molds for thermoforming are generally much lighter than the molds for impregnation.

The method advantageously comprises the step consisting of consolidating the polymer or polymers after the impregnation step, by solidification of the polymer or polymers when they are thermoplastic polymers or by baking the polymer or polymers when they are thermosetting polymers, and of removing the part thus obtained from the mold.

The method may be used in several places of one and the same production unit or of several production units. It may also be used by linking the steps or by spacing them, in time. For example, several thermoformed preforms may be produced, stored notably in a stack, and subsequently moved, one by one, into a mold for the impregnation step. From an industrial standpoint, the method according to the invention makes it possible to produce the preform and carry out its impregnation with polymer at sites that are far apart.

When it is used, the seaming step makes it possible to stabilize the preform, by keeping the plies in their draped position, thus allowing the latter to be handled without risk of loss of cohesion or misalignment of the plies. Seaming makes it possible to bond the plies without excessively hampering their capacity for deformation. Seaming is advantageously carried out along a predetermined contour, for example along a contour of folding of the preform. The seam may be effected as a zigzag, so as to ensure cohesion of the different plies of the preform without impairing the ability of the preform to deform, with which it is endowed by the nature of the plies deposited. The seaming step may take place, when there is a sandwich structure, after placement of the core or cores and draping of the second layered structure.

When draping is carried out on a three-dimensional mold cavity, not flat, a series of rollers may be provided in the tooling for applying draping on the mold cavity and gradually forming the preform.

When present, the core or cores may be of foam, notably of foamed polyethylene terephthalate (PET), preferably molded. PET foam has several advantages, including reduced cost, resistance to a temperature of 200° C., capacity for being thermoformed, as well as the possibility of being recycled. The core or cores may be pierced with a plurality of holes with a diameter between 1 mm and 5 mm, in order to facilitate the impregnation step, notably of injection or infusion, of polymer over said cores.

Still in this case, said at least one core advantageously has a total external surface area less than that of at least one of the plies so that only certain predetermined zones of the layered structure are covered.

At least one ply may be cut out before draping according to predetermined dimensions. Thus, it is possible to avoid losing material through generation of unused offcuts of material, which makes it possible to reduce costs and the amount of waste. In fact, in this case, just the necessary amount of material is used. Another advantage connected with this previous cutting out is that it makes it possible to avoid or minimize completion, i.e. the steps of finishing the part, such as deburring, trimming, recovery for piercing, etc., after consolidation of the polymer or polymers, steps that may be long and expensive. Thus, owing to the invention, the production time may be reduced, some or all of these completion steps being avoided. In fact, the part obtained by the method is said to be of definitive shape, or “net-shape”, or of almost definitive shape, called “near net-shape”.

Each ply may comprise a weight between 100 g/m² and 5000 g/m², notably relatively large, for example greater than 3000 g/m². This makes it possible to reduce the duration of the draping operations. The thickness of a ply may thus be between 0.3 mm and 5 mm, notably greater than 3 mm.

At least one of the plies may act as reinforcement of certain zones of the preform.

Said at least one polymer impregnating the preform may be selected from thermosetting resins, such as unsaturated polyester resins, vinyl ester resins, epoxy resins, acrylic resins, phenolic resins, polyimide resins, bismaleimide resins, polystyrylpyridine resins, and thermoplastic resins such as polycarbonates, polyamides, notably aliphatic polyamides, such as polycaprolactam PA 6, polyhexamethylene adipamide PA 6.6.

It should be noted that, owing to the invention, it is possible to use inexpensive materials, notably one or more polymers for impregnation of the preform. For example, it is possible to use thermosetting epoxy resins, which are less expensive than high-performance thermoplastic resins, it being understood that the latter may however also be used.

The step of impregnating the dry preform with a polymer may employ a method selected from the group consisting of resin transfer molding (RTM), light resin transfer molding (RTM Light), high-pressure resin transfer molding (HP-RTM), thermoplastic resin transfer molding (T-RTM), resin transfer molding with deposition of liquid resin on the open mold (RTM/Liquid Compression Molding LCM), thermoplastic thermo-stamping, using the dry preform and a thermoplastic matrix in the form of powder or of a plate, compression-transfer molding and infusion molding.

At least one of the draping steps is advantageously carried out by copying a tooling profile or by programming a robot. When draping is carried out by copying, the robot is not programmed but follows a mark or profile on the tooling. This makes it possible to change the part reference quickly, without having to modify a machine program. It is the tooling itself that guides the robot's path.

For making any piercings necessary for fixing other parts, the method may comprise a step of piercing the preform using at least one needle before impregnation of the preform with the polymer. In this case, the impregnating mold may comprise at least one moving needle traversing the layered structure or structures, and optionally the core. A shaft of injection resin, pultruded or mechanical, is then produced, at the level of the piercing. In the monolithic zones, the use of needles in the mold makes it possible to make holes directly during molding. In the case of a sandwich structure, it may be necessary to reinforce the hole. For this, one proposal is to provide a local recess in the material of the core, which will become filled with polymer to create a shaft binding the plies. It is also possible to equip the core material with pultruded shafts, which will perform the same function.

Alternatively, one or more inserts, notably metallic or thermoplastic, may be provided in the preform.

Owing to the method according to the invention, various parts intended for example for the automotive sector may be produced, automatically, at a high rate, with limited storage space. For example, a part may be produced, employing the method described above, in a time between about 2 min and 5 min, notably in less than about 200 s, including for example 90 s for making the preform and 90 s for impregnating the preform with at least one polymer.

More broadly, the method according to the invention makes it possible, through assembly of subassemblies with very varied and different geometries and materials, to provide various forms of functionalization of the part, as described below.

According to some embodiments, the positioning of the plies relative to one another is defined so as provide at least one zone, having a function, between the plies.

For example, at least one empty space deliberately left between plies or layers of plies delimits at least one zone that is able, at the end of the forming (thermoforming) process and then injection, to form at least one cavity for circulation of a fluid (heating fluid or cooling fluid, for example) within the finished part. This makes it possible to avoid adding, by assembly that would be complex and fragile (welding etc.), additional components (tubes, coils, etc.) intended for said circulation of fluid.

At least one such zone not occupied by plies or layers of plies may also delimit at least one cavity or a projection of suitable geometry capable of receiving at least one part that is to be combined with the final part, also without a complex assembly operation (welding, etc.). For example, the finished part is an assembly forming a pack/tank for receiving energy-producing elements. For example, the part is a battery, also called “battery pack” for the automotive sector, in the form of a case made of a composite material, for example thermoplastic (with reinforcement typically with long fibers), providing, owing to this or these cavities, sites (of the male or female type) for receiving batteries (for example 30 to 50 cells approximately vertically for a pack with a length of one meter). If applicable, this variant is combined with the preceding variant (circulation of fluids) to additionally provide the functionality of cooling the pack.

Thus, according to these two embodiments, draping of the plies is defined so as to provide, between the plies, at least one zone having a function, said at least one zone having a function being a cavity for circulation of a fluid within the finished part and/or said at least one zone having a function that is a cavity or a projection of a suitable geometry capable of receiving an element that is to be combined with the final part.

According to other embodiments, the choice of the material itself also confers a particular functionality. For example, the use of at least one ply of carbon-fiber fabric supplies a function of conduction or dissipation of heat. Returning to the example of the “battery pack”, the preform of the part may comprise at least one ply of carbon-fiber fabric located at the places where the dissipation function is required. For example, these carbon fibers are obtained from PAN (polyacrylonitrile) or from biosourced precursors. For example, the method will use at least one ply of precursor fabric that has undergone a carbonization step: the precursor fabric prepared undergoes a carbonization step to give a carbon fiber fabric that is used as a ply for making the preform as described in the present application. In this case, in the method according to the invention, at least one ply of carbon-fiber fabric is used for supplying a function of conduction or dissipation of heat.

According to other embodiments, functionalization of the preform is provided by inserting at least one sensor, notably several sensors, in the preform, which are special “active” inserted elements able to withstand the stresses of the method described in the present application, and/or “passive” zones or inserted elements, the state of which reflects the state of health of the part and/or of the material.

Installation

The invention also relates to an installation for carrying out the method as defined above. Such an installation comprises, for example, at least one flat or shaped draping zone, a thermoforming or preforming zone and a zone for impregnation with at least one polymer, for example by injection.

Column Support

According to another of its aspects, independently or in combination with all or part of the foregoing, the invention also relates to a steering column support for a motor vehicle, comprising an upper part made of composite material having an organic matrix, which may, at least partially, have a sandwich structure, configured for holding the steering column at the front, and shaped for being fixed at the back on the lower crossmember of the vehicle's windshield recess. The upper part advantageously has a sandwich structure, at least partially, so as to form a rigid zone maintaining the position of the steering wheel.

The expressions “at the front” and “at the back”, “downwards” are relative to a driver present in the final vehicle sitting in the driver's seat facing the steering wheel. The “front” side is thus the closest to the driver, whereas the “back” side is farthest from him, “downwards” denoting a direction toward his feet.

According to one embodiment, the support is produced by the method as defined above, notably comprising the step of flat draping. The support is in this case an example of a part produced by this method.

The support may comprise, besides the upper part, a lower part made of composite material having an organic matrix, extending downwards and at the back of the upper part and shaped for being fixed to the vehicle's front bulkhead and to carry the vehicle's pedal bracket. In this case, the lower part may be produced with the upper part in a monolithic form. The lower part need not be made as a sandwich structure, not comprising core(s) between the layers. The lower part may be made for replacing part of the vehicle's front bulkhead and have stiffness similar to that of a front bulkhead made of steel. It may be designed to deform in the case of a frontal impact.

The support may comprise a strut, notably made of metal, preferably of steel, extending downwards between the upper part, at the front, and the vehicle's front bulkhead or the lower part of the support. Such a strut, fixed mechanically to the upper part of the column support, is configured, when present, for absorbing the exceptional forces at the level of the steering wheel, providing vibratory stiffness, and this strut is advantageously dimensioned so as to buckle in the case of frontal impact. The strut may, as a variant, be made of composite material having an organic matrix.

The column support may be pre-assembled with the vehicle's pedal bracket and/or steering column, before installation in the vehicle.

Windshield Recess Lower Crossmember

According to another of its aspects, independently or in combination with all or part of the foregoing, the invention also relates to a windshield recess lower crossmember, intended to extend over the full width of the interior of a vehicle, made of a composite material having a polymer matrix, which may, at least partially, have a sandwich structure, produced by the method as defined above.

To obtain such a part, the method employed may comprise draping on a three-dimensional mold cavity having the shape desired for the part. The shape of the windshield recess lower crossmember may be constrained by the double-curvature shape of the windshield, which may preclude the use of flat draping. The evolute of the windshield recess lower crossmember is advantageously constant, which may allow draping to be carried out automatically.

The windshield recess lower crossmember is advantageously intended to be fixed to the back of the upper part of the steering column support as defined above.

The windshield recess lower crossmember advantageously has a sandwich structure in the region where it is fixed to the column support. Below this fixing region, the windshield recess lower crossmember is advantageously extended by a more flexible portion, not of sandwich structure, and this portion can buckle in the case of frontal impact.

Steering Column Support/Windshield Recess Lower Crossmember Assembly

According to another of its aspects, independently or in combination with all or part of the foregoing, the invention also relates to an assembly of steering column support as defined above and windshield recess lower crossmember as defined above, intended to be mounted in a motor vehicle.

In this case the support may or may not be pre-assembled with the pedal bracket and/or steering column before fixing to the windshield recess lower crossmember. Motor vehicle

According to another of its aspects, independently or in combination with all or part of the foregoing, the invention also relates to a motor vehicle comprising a steering column support as defined above and a windshield recess lower crossmember as defined above, fixed together, the column support extending over only part of the length of the windshield recess lower crossmember.

Part

The invention also relates to any part produced using the method as described above, intended for the automobile, aeronautical or shipbuilding sector or other industrial sector. In particular, the part may consist of a composite spring plate with hinges for joining to the motor vehicle floor.

Heat Exchanger

The invention also relates to a heat exchanger comprising at least one part made of composite material produced by the method as defined above, comprising at least one cavity for circulation of a fluid within the finished part.

Battery

The invention also relates to a battery comprising at least one part made of composite material produced by the method as defined above, comprising at least one cavity or projection of suitable geometry, able to receive at least one electric battery.

### FIGURES

The invention may be better understood on reading the description given hereunder, of nonlimiting embodiment examples of the invention, and on examining the appended drawing, in which:

FIG. 1 shows, schematically and in perspective, an example of a steering column support according to the invention, pre-assembled,

FIG. 2 shows, schematically and partially, in perspective, the pre-assembled column support in FIG. 1 with a windshield recess lower crossmember according to the invention,

FIG. 3 shows, schematically and partially, in perspective, the assembly of column support and windshield recess lower crossmember in FIG. 2 mounted on the front bulkhead of a vehicle,

FIG. 4 shows in cross section, schematically and partially, an example of column support and windshield recess lower crossmember according to the invention assembled together,

FIG. 5 shows, schematically and partially, the column support and the windshield recess lower crossmember in FIG. 4 before assembly,

FIG. 6 shows another example of column support and windshield recess lower crossmember according to the invention after assembly,

FIG. 7 shows the assembly of column support and windshield recess lower crossmember in FIG. 6 before assembly,

FIG. 8 shows the assembly in FIG. 4 after a frontal impact,

FIGS. 9, 10, 11 and 12 show, schematically and partially, the method for producing the column support in FIG. 1,

FIG. 13 shows the piercing step of the method for producing the part,

FIG. 14 shows, schematically and in perspective, the preform after the piercing step in FIG. 13,

FIG. 15 shows, schematically and in perspective, the industrial installation for carrying out the method of FIGS. 9 to 12,

FIG. 16 is an enlarged view of a part of the installation in FIG. 15,

FIG. 17 shows in cross section, schematically and in isolation, the windshield recess lower crossmember according to the invention,

FIGS. 18, 19, 20 and 21 show schematically the various steps of the method for producing the windshield recess lower crossmember in FIG. 17,

FIG. 22 shows the various steps in the production of the windshield recess lower crossmember, in schematic perspective views,

FIG. 23 shows, schematically and in perspective, the draping tooling used for making the windshield recess lower crossmember,

FIG. 24 shows, schematically and in perspective, the installation for carrying out the method in FIGS. 18 to 21,

FIG. 25 is an enlarged view of a part of the installation in FIG. 24,

FIG. 26 shows in cross section, schematically and partially, an example of a heat exchanger according to the invention,

FIG. 27 shows in cross section, schematically and partially, an example of a battery according to the invention,

FIG. 28 shows in cross section, schematically and partially, an example of insertion of a sensor in a part produced by the method according to the invention.

### DETAILED DESCRIPTION

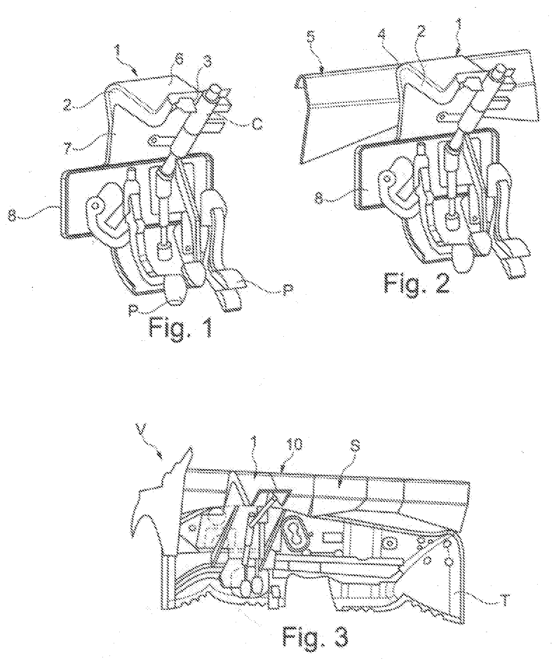

FIG. 1 shows a steering column support 1 according to an embodiment example of the invention, intended for a motor vehicle, on which the pedal bracket P of the vehicle and the steering column C of the vehicle have been pre-assembled.

The steering column support 1, in this example, is made of composite material having an organic matrix, according to the method of production described below.

The column support 1 comprises an upper part 2 made of composite material having an organic matrix, in this example having a sandwich structure at least partially, configured for holding the steering column C at the front 3. As can be seen in FIG. 2, the upper part 2 is also shaped for being fixed at the back 4 on the windshield recess lower crossmember 5 of the vehicle. In this example, the upper part 2 is L-shaped with a relatively flat portion 6 extending from the front 3 to the back 4 and a part 7 extending downwards at the back.

The support 1 also comprises, in the prolongation of part 7, in this example, a lower part 8 in the approximate shape of a curved cross, arranged for carrying the pedal bracket, as can be seen in FIGS. 1 to 3. The lower part 8 is made of composite material having an organic matrix, not in the form of a sandwich structure but in the form of stacked layers made in one piece with the upper part 2. In this example, this lower part 8 replaces a part of the steel front bulkhead of the vehicle to which it is intended to be fixed and advantageously has stiffness comparable to that of a front bulkhead made of steel.

The drawing also shows a windshield recess lower crossmember 5 according to an embodiment example, shown in FIGS. 2 and 3, fixed to the support 1. The windshield recess lower crossmember 5 extends transversely over the full width of the vehicle, and has a shape with double curvature matching that of the vehicle's windshield. The support 1 is advantageously fixed to the windshield recess lower crossmember 5 by screwing and/or gluing.

FIG. 3 shows, arranged in a vehicle V shown very partially, the assembly 10 formed by the support 1, pre-assembled in this example with the pedal bracket P and the steering column C, and the windshield recess lower crossmember 5. The whole is mounted on the bulkhead T. It should be noted that the shape and the mechanical properties of the windshield recess lower crossmember 5, the shape of which is a hollow body, make it possible to dispense with a metal crossmember, which allows new designs of dashboards to be conceived.

Moreover, compared to assemblies made from metal parts, a smaller number of parts is required to fulfill the same functions.

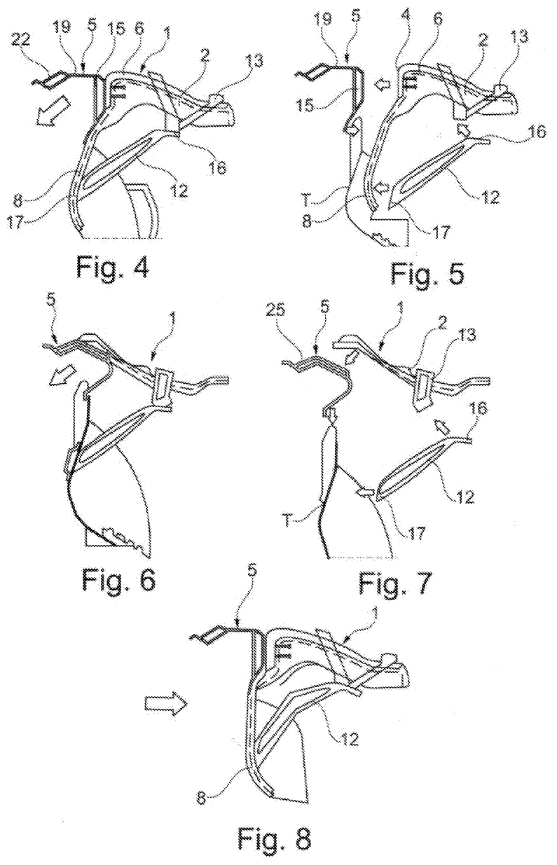

The windshield recess lower crossmember 5 is made of a composite material having an organic matrix, in this example partially as a sandwich structure incorporating one or more cores on some or all of its length. As can be seen in FIG. 4, in cross section the windshield recess lower crossmember 5 has a hollow shape, approximately U-shaped, on its whole length.

As can also be seen in FIG. 4, the column support 1 comprises a strut 12, made at least partially in this example of a metallic material such as steel, fixed in this example on the one hand by an upper end 16, to the upper part 2 of the column support 1 via a fixing system 13 and on the other hand, by a lower end 17, to the lower part 8 of the column support 1.

For its part, the lower part 8 is fixed to the metal bulkhead T of the vehicle, as shown in particular in FIG. 5.

In this example, the windshield recess lower crossmember 5 has a fixing part 15 with a sandwich structure matching the shape of the column support 1 at the back 4 of its upper part 2. This fixing part 15 is approximately vertical. The windshield recess lower crossmember 5 further comprises an approximately horizontal upper part 19, in the prolongation of the flat portion 6 of the upper part 2, as well as a reinforced portion with a sandwich structure 22 extending downwards at the back under the vehicle's windshield. The various parts are fixed and assembled according to the arrows in FIG. 5, by gluing and/or mechanical fastening, notably by screwing.

As illustrated in FIG. 8, the strut 12 is configured so as to buckle in the case of frontal impact, and the lower part 8 of the column support 1 is also designed to deform.

Another example of a support 1 and a windshield recess lower crossmember 5 is illustrated in FIGS. 6 and 7. In this example, the windshield recess lower crossmember 5 comprises a single sandwich structure zone 25 extending under the support 1, which comprises only an upper part 2 and a strut 12. In this example, the strut 12 is fixed by its upper end 16 to the fixing system 13 and by its lower end 17 to the bulkhead T. Moreover, the windshield recess lower crossmember 5 is fixed to the support 1 and to the bulkhead T, as can be seen in FIG. 7.

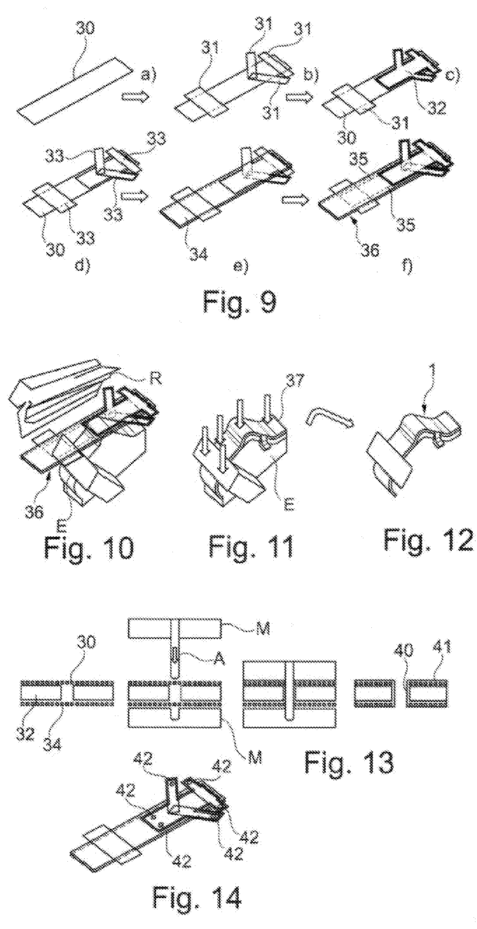

FIGS. 9 to 14 show the different steps of the method for producing a complex part made of composite material having an organic matrix, in this example having a sandwich structure at least partially, a part such as the column support 1 illustrated in FIGS. 1 to 3.

FIG. 9 shows a step a) of flat draping of a layered structure comprising a first deformable dry ply 30 of rectangular shape with predetermined dimensions.

Step b), also illustrated in FIG. 9, consists of flat draping of a second deformable dry ply 31 with several pieces with predetermined dimensions and positioning and corresponding to the desired shape. As can be seen, the second ply 31 only partially covers the first ply 30 and the orientation and shape of the pieces are different than the latter. The nature and weight of the second ply 31 may be identical to or different than of the first ply 30, depending for example on the mechanical properties required. The layered structure is, for example, held on the table of the draping machine by vacuum.

Step c) consists of placement, on a predetermined part of the surface of the layered structure consisting of plies 30 and 31, of a core 32 of foamed polyethylene terephthalate. The core or cores 32 may be glued on the layered structure.

If the core is not made of foamed PET or if there is no core, this will still be within the scope of the invention. Any other material suitable for the method may be used, including a metal insert, for example made from formed or cast sheets, so as to have a function appropriate to the application: material for damping, strength, sound or heat insulation, conductive or insulating material for example.

The next step d) consists of flat draping of a second layered structure once again comprising a deformable dry ply 33 corresponding to ply 31, at least in shape.

In a step e), a deformable dry ply 34, identical at least in shape to ply 30, is draped flat, forming the second layered structure with ply 33. The relative flexibility of the core does not interfere with the draping of these plies 33 and 34. According to a variant embodiment, the plies 33 and 34 making up the second layered structure are stabilized on the preform by thermal activation of a polymer, for example a thermoplastic polymer, dusted on said plies, or by spraying of glue.

In this step e), it can clearly be seen that one part, in the present case the upper part 2 of the column support 1, is made as a sandwich structure whereas the other part, namely the lower part 8 of the column support 1, is made in one piece with the upper part 2 but without the core and therefore the sandwich structure.

In this example the plies 30, 31, 33 and 34 are advantageously nonwoven plies of NCF, with a weight selected so as to obtain the desired stiffness without multiplying the number of plies required. For example, a ply in NCF, used for making the column support 1 or for any other part produced by the method according to the invention, comprises a first layer of carbon fibers oriented at +45°, a second layer of aramid fibers oriented at 0°, and a third layer of carbon fibers oriented at −45°, without this example being limiting or exhaustive. Thus, the nature of the fibers that are draped is adapted to meet the needs of mechanical durability with respect to stresses during use of the part made and the requirements in an exceptional stress situation, such as in the case of an impact or penetration of a foreign body. If the preform comprises for example glass fibers, carbon fibers, kevlar fibers or natural fibers, among others, this will still be within the scope of the invention.

In a step f), at least one seam 35 of the plies is produced, so as to keep the two layers together. The seam 35, preferably in zigzag, may follow the contour of the core or cores so as to allow separation of the layers on either side of the core or cores, reinforcing this separation zone against peeling. As a variant or additionally, the seam 35 may constitute one or more lines of folding of the preform. The location of the seam 35 is determined for example by experience or by simulation. The seam may be produced by a seaming system bonding the plies together to fix their position. Such a system may have two needles or one curved needle. In both cases, a buffer zone is provided under the preform for receiving the needles. The speed of producing the seam may be about 1400 stitches/min, or about 10 cm/s.

In a variant embodiment that is not shown, the seam or seams under most stress are covered with bands of unidirectional fibers, for example of carbon fibers, in order to reinforce them. The fibers of said bands are oriented approximately parallel to the general direction of progression of the seams that they cover.

A flat dry preform 36 is then obtained. As illustrated in FIG. 10, the flat dry preform 36 obtained in step f) is moved into a three-dimensional cavity E of a mold and a radiant panel R heats it to a temperature of about 100° C., in such a way that, as illustrated in FIG. 11, the preform matches the shape of the cavity E.

The thermoformed preform 37 thus obtained is then moved into a second mold, not visible in the figures, in which it is impregnated with at least one polymer in order to produce the part, shown in FIG. 12, in this example constituting the support 1 described above. In a manner known per se, the impregnation step may consist of a step of injection molding of material, of the resin transfer molding type RTM, light resin transfer molding (called RTM light), at high-pressure HP-RTM, thermoplastic resin transfer T-RTM or others. Molding may also be of the compression transfer type, for example employing one or more thermoplastic polymers in sheet or powder form, or some other type, comprising for example an infusion step.

The polymer used for impregnation may be a thermosetting or thermoplastic resin.

According to an embodiment example that is not illustrated, the second mold comprises two parts and sealing means so that, when the mold is closed, said two parts define a sealed cavity in which the dry preform is located. The mold comprises means for vacuuming said cavity, and according to one embodiment example, means for heating each part of the mold. According to various embodiment examples, the two parts of the mold are heated by circulation of a fluid, by electric resistances or by induction. When the preform is under vacuum in the mold cavity, channels allow a polymer to be injected into the preform, so as to impregnate it. This injection is carried out at a temperature appropriate to the polymer used. Injection may be carried out at high pressure, for example of about 30 bar, and at high temperature, notably between 120° C. and 180° C. The mold may be made of metal, notably steel. According to one embodiment example, polymers of different nature are injected into the upper part and into the lower part of the mold and/or in specific zones of the upper and/or lower parts, in order to confer suitable properties on the part as a function of the stressing to which it is subjected.

After consolidating the part 1 by solidification of the polymer when it is a thermoplastic polymer or by baking the polymer when it is a thermosetting polymer, the part 1 is removed from the mold. Simple deburring, not machining, may be carried out to finish the part 1.

With such a method, the rate for production of one part may be less, in cumulative time, than 200 s, the steps of draping and of impregnation, notably injection, each requiring 90 s.

FIGS. 13 and 14 show a step of piercing the preform, which may take place during production of the latter. The mold M comprises a moving needle A, which is inserted through the plies 30 and 34 and optionally the core 32 as can be seen. During injection of material, the impregnating polymer forming the matrix 41 of part 1 will also create a shaft 40 surrounding the pierced hole. FIG. 14 shows the locations for piercing 42 provided in part 1, which, in another embodiment, may be produced by placement of metal inserts, pre-existing in the material of the core or cores.

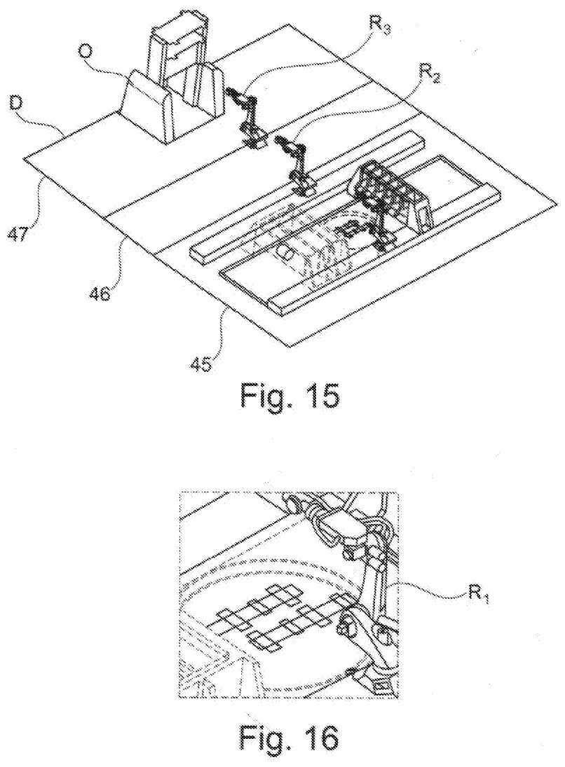

An installation D for carrying out the method in FIGS. 9 to 14 is illustrated in FIGS. 15 and 16. FIG. 15 shows a first flat draping zone 45, a second preforming or thermoforming zone 46, and finally a third zone for impregnation 47 with a polymer, for example by injection. The flat draping zone 45 is more visible in FIG. 16, notably illustrating the fact that four preforms may be produced, notably draped, simultaneously with this installation D, by using a 300t injection press in this example.

A robot R1 performs the flat draping automatically. A second robot R2, visible in FIG. 15, allows the flat preforms to be moved to the second zone 46, for example by a gripping effector, with needles or with vacuum, preferably with needles.

In the third zone 47, besides a robot R3 arranged for moving the thermoformed preforms to the third zone 47, tooling O including the mold for impregnation, notably by injection, of polymer into the preform is shown. In this example the tooling is an injection device such as a press.

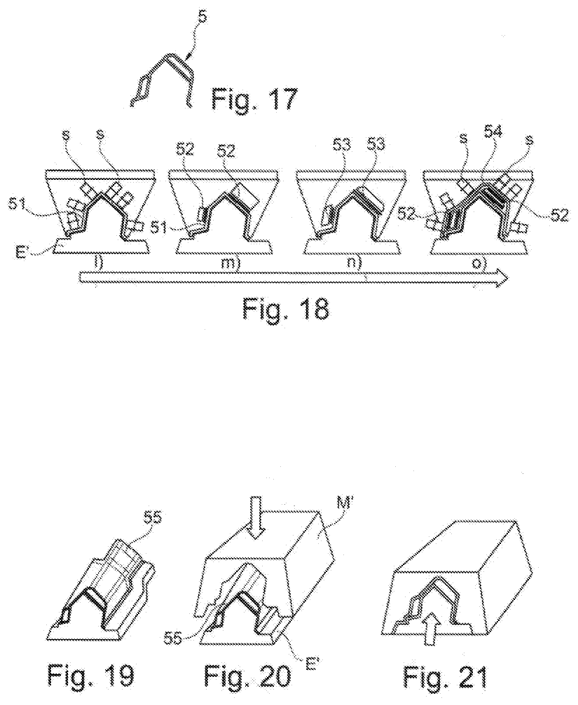

FIG. 17 shows in isolation the windshield recess lower crossmember 5, in cross section. It is of a hollow shape, with an open section. The sandwich structure makes it possible to endow the part with stiffness, by selecting carbon fibers for the most heavily stressed parts or pieces and glass fibers for the parts or pieces under less stress.

The method for producing the latter is illustrated in FIGS. 18 to 23. FIG. 18 shows a step l) of mold draping on a cavity E′ having a three-dimensional surface. Draping is carried out automatically using small rollers S draping a little at a time, forming a layered structure comprising in this example a first deformable dry ply 51 of NCF.

In step m), second plies 52, constituting reinforcement, are positioned on certain zones of the first ply 51. These plies 52 are for example made of carbon fiber cloth.

Then, in step n), cores 53, numbering two in this example, are positioned on a part of the first layered structure 51, in the present case on plies 52.

In step o), a second layered structure 54, comprising in this example a deformable dry ply of NCF, is produced automatically using the rollers S. It should be noted that plies 52 were also deposited beforehand above the cores 53, as can be seen in this step o).

A preforming step, or thermoforming step, at low pressure, of the order of 1 bar, and at low temperature, below 100° C., is carried out after step o), in a simple mold, for example of aluminum or of composite material having an organic matrix, or of resin, or some other.

The three-dimensional preform 55 obtained is shown in perspective in FIG. 19. The preform 1 is moved to another mold where, as can be seen in FIG. 20, a countermold M′ is arranged on the preform 55.

In the step illustrated in FIG. 21, a thermosetting resin is injected into the mold so as to impregnate the preform 55 with a polymer. After consolidation, in this example by baking the resin, the part can be removed from the mold.

It should be noted that the features described above for the preform, the materials used, the steps of the method as well as the tooling, with respect to FIGS. 9 to 12, even if not included in the description, may be identical, at least for some of them, to those of the preform, materials, tooling, and steps of the method in FIGS. 18 to 21.

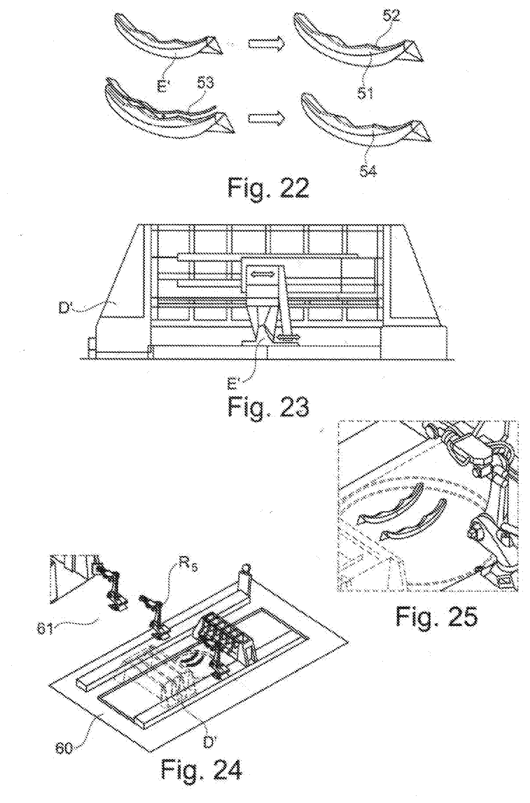

FIG. 22 illustrates the same steps as those illustrated in FIG. 18, except that the part is shown in perspective. It shows the draping tools and then the step of mold draping of the first ply 51 and placement of the second plies 52 and then adding the cores 53 and finally mold draping of a second layered structure with the plies 52 and 54.

An example of tooling that may be used for mold draping is shown in FIG. 23. For draping this complex shape, preferably automatic draping is used by indexing the lateral displacement of the fabric rollers in a groove of the tooling, of suitable profile, rather than by programming the robot. This simplifies the programming of the means and the process of changing the part reference.

With the complete installation illustrated in FIG. 24 it is possible to produce two preforms of windshield recess lower crossmember simultaneously. The draping zone 60 is juxtaposed with an injection zone 61, and a robot R5 makes it possible to move, with a gripping effector, the preforms produced using the tooling D.

The method, the steps of which are illustrated in FIGS. 9 to 12 and 18 to 21, may be used for making parts other than a steering column support or a windshield recess lower crossmember.

In particular, such a method may allow high-rate production of any complex parts made of composite material having an organic matrix that may comprise at least one part having a sandwich structure, whether intended for the automotive sector, aeronautical sector or other industrial sectors.

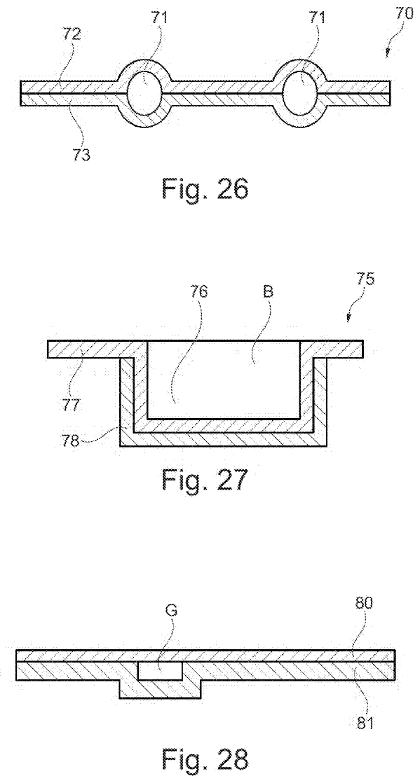

Other parts produced using the method of the invention are illustrated in FIGS. 26 and 27.

FIG. 26 shows, partially, a heat exchanger 70 comprising at least one, in this example two cavities 71 for circulation of a fluid within the finished part, made between the plies 72 and 73.

FIG. 27 shows, partially, a battery 75 comprising at least one cavity 76 of suitable geometry, made from two plies 77 and 78, able to receive at least one electric battery B. In an example not illustrated, at least one projection could be made.

FIG. 28 illustrates the possibility of incorporating a sensor G between two plies 80 and 81 in a part produced by the method according to the invention.

It should be noted that the steps of the method according to the invention for producing the preform or preforms may be carried out independently of the final step of impregnation with a polymer in order to produce the part. The dry preforms may be stored in a stack to save storage space. The final step of the method may be carried out subsequently after a time lapse that may be for example from 1 h up to a year. As a variant, all the steps of the method may be carried out successively, without delay, i.e. in less than about 1 h, notably of the order of some minutes at most.

1. A method for producing a part made of composite material having an organic matrix and fiber reinforcement for battery, said method comprising the following steps:
a) automatically draping, either flat or shaped on a three-dimensional mold cavity, at least one layered structure comprising at least one first and one second different dry plies, at least partially superposed, so as to form a dry preform, either flat or three-dimensional, each ply being fibrous, the plies differing from one another in structure, positioning on the preform, the fibers of which they are constituted and/or the geometry of the ply, the positioning of the plies relative to one another being defined so as provide at least one zone, having a function, between the plies,
b) thermoforming the preform, thermoforming being carried out, when it was draped flat in step a), in a three-dimensional cavity of a first mold in order to give it a three-dimensional shape,
c) impregnating, within a mold, the preform thus thermoformed with at least one polymer, the preform being moved, in the case of draping flat in step a), from the first thermoforming mold to a second mold for impregnation.

2. The method as claimed in claim 1, each ply being in the form of a structure selected from the group consisting of a linear structure, a surface structure, or multidirectional.

3. The method as claimed in claim 1, comprising a step consisting of placing at least one core on at least one part of the layered structure, said at least one core, having a total external surface area less than that of at least one of the plies so that only certain predetermined zones of the layered structure are covered.

4. The method as claimed in claim 3, comprising the step of draping a second layered structure comprising at least one ply in order to cover the core and the layered structure at least partially.

5. The method as claimed in claim 1, in which said at least one zone having a function is a cavity for circulation of a fluid within the finished part and/or said at least one zone having a function being a cavity or a projection of suitable geometry, able to receive an element that is to be combined with the final part.

6. The method as claimed in claim 1, in which at least one ply of carbon-fiber fabric is used for supplying a function of conduction or dissipation of heat.

7. The method as claimed in claim 1, in which at least one sensor is inserted in the preform.

8. A battery comprising at least one part made of composite material produced by the method as claimed in claim 1, comprising at least one or projection of suitable geometry, able to receive at least one electric battery.

9. The battery according to claim 8, wherein said at least one zone having a function is a cavity for circulation of a fluid within the finished part in order to allow the cooling of the battery.

10. The battery according to claim 9, comprising at least one ply of carbon-fiber fabric for supplying a function of conduction or dissipation of heat,

11. The battery according to claim 10, wherein the carbon fibers are obtained from PAN (polyacrylonitrile) or from biosourced precursors.

12. The method according to claim 5, wherein said at least one zone having a function is a cavity or a projection of suitable geometry able to receive an element that is to be combined with the final part, wherein the cavity or cavities are sites of the male or female type for receiving batteries.

13. The method according to claim 12, wherein the cavities comprise 30 to 50 cells approximately vertically for a battery with a length of one meter.

14. The battery according to claim 8, wherein said at least one zone having a function is a cavity for circulation of a fluid within the finished part in order to allow the cooling of the battery.

15. The method according to claim 6, wherein the carbon fibers are obtained from PAN (polyacrylonitrile) or from biosourced precursors.

16. The method according to claim 13, wherein at least one ply of precursor fabric that has undergone a carbonization step is used.
